(19) United States
(12) Patent Application Publication
(10) Pub. No.: US 2008/0104362 A1
(43) Pub. Date: May 1, 2008

(54) Method and System for Performance-Driven Memory Page Size Promotion

(76) Inventors: William M. Buros, Austin, TX (US); Kevin X. Lu, Brooklyn, NY (US); Santhosh Rao, Austin, TX (US); Peter W. Y. Wong, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/552,652

(22) Filed: Oct. 25, 2006

(51) Int. Cl. G06F 12/00

(52) U.S. Cl. 711/207

(57) ABSTRACT

A method, system, and computer program product enable the selective adjustment in the size of memory pages allocated from system memory. In one embodiment, the method includes, but is not limited to, the steps of: collecting profile data (e.g., the number of Translation Lookaside Buffer (TLB) misses, the number of page faults, and the time spent by the Memory Management Unit (MMU) performing page table walks); identifying the top N active processes, where N is an integer that may be user-defined; evaluating the profile data of the top N active processes within a given time period; and in response to a determination that the profile data indicates that a threshold has been exceeded, promoting the pages used by the top N active processes to a larger page size and updating the Page Table Entries (PTEs) accordingly.

### BACKGROUND OF THE INVENTION

1. Technical Field

The present invention relates in general to a method and system for data processing and in particular to memory management. Still more particularly, the present invention relates to an improved method and system for adjusting page sizes allocated from system memory.

2. Description of the Related Art

The memory system of a typical personal computer includes one or more nonvolatile mass storage devices, such as magnetic or optical disks, and a volatile random access memory (RAM), which can include both high speed cache memory and slower main memory. In order to provide enough addresses for memory-mapped input/output (I/O) as well as the data and instructions utilized by operating system and application software, the processor of a personal computer typically utilizes a virtual address space that includes a much larger number of addresses than physically exist in RAM. Therefore, to perform memory-mapped I/O or to access RAM, the processor maps the virtual addresses into physical addresses assigned to particular I/O devices or physical locations within RAM.

In the PowerPC™ RISC architecture, the virtual address space is partitioned into a number of memory pages, which each have an address descriptor called a Page Table Entry (PTE). The PTE corresponding to a particular memory page contains the virtual address of the memory page as well as the associated physical address of the page frame, thereby enabling the processor to translate any virtual address within the memory page into a physical address in memory. The PTEs, which are created in memory by the operating system, reside in Page Table Entry Groups (PTEGs), which can each contain, for example, up to eight PTEs. According to the PowerPC™ architecture, a particular PTE can reside in any location in either of a primary PTEG or a secondary PTEG, which are selected by performing primary and secondary hashing functions, respectively, on the virtual address of the memory page. In order to improve performance, the processor also includes a Translation Lookaside Buffer (TLB) that stores the most recently accessed PTEs for quick access.

Although a virtual address can usually be translated by reference to the TLB because of the locality of reference, if a TLB miss occurs, that is, if the PTE required to translate the virtual address of a particular memory page into a physical address is not resident within the TLB, the processor must search the PTEs in memory in order to reload the required PTE into the TLB and translate the virtual address of the memory page. Conventionally, the search, which can be performed either in hardware or by a software interrupt handler, sequentially examines the contents of the primary PTEG, and if no match is found in the primary PTEG, the contents of the secondary PTEG. If a match is found in either the primary or the secondary PTEG, history bits for the memory page are updated, if required, and the PTE is loaded into the TLB in order to perform the address translation. However, if no match is found in either the primary or secondary PTEG, a page fault exception is reported to the processor and an exception handler is executed to load the requested memory page from nonvolatile mass storage into memory.

PTE searches utilizing the above-described sequential search of the primary and secondary PTEGs slow processor performance, particularly when the PTE searches are performed in software. The use of larger page sizes typically reduces TLB misses, but results in inefficient usage of memory since the entire portion of memory allocated to a large page may not always be utilized. Consequently, an improved method for selectively adjusting the size of memory pages is needed.

### SUMMARY OF THE INVENTION

Disclosed are a method, system, and computer program product for selectively adjusting the size of memory pages. In one embodiment, the method includes, but is not limited to, the steps of: collecting profile data (e.g., the number of Translation Lookaside Buffer (TLB) misses, the number of page faults, and the time spent by the Memory Management Unit (MMU) performing page table walks); identifying the top N active processes, where N is an integer that may be user-defined; evaluating the profile data of the top N active processes within a given time period; and in response to a determination that the profile data indicates that a threshold has been exceeded, promoting the pages used by the top N active processes to a larger page size and updating the Page Table Entries (PTEs) accordingly.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary data processing system, as utilized in an embodiment of the present invention;

FIG. 2 illustrates a page table in memory, which contains a number of Page Table Entries (PTEs) that each associate a virtual address of a memory page with a physical address;

FIG. 3 illustrates a pictorial representation of a Page Table Entry (PTE) within the page table depicted in FIG. 4;

FIG. 4 depicts a more detailed block diagram of the data cache and Memory Management Unit (MMU) illustrated in FIG. 1;

FIG. 5 is a high level flow diagram of the method of translating memory page addresses employed by the data processing system illustrated in FIG. 1; and

FIG. 6 is a high level logical flowchart of an exemplary method of adjusting the size of memory pages in accordance with one embodiment of the invention.

### DETAILED DESCRIPTION OF AN ILLUSTRATIVE EMBODIMENT

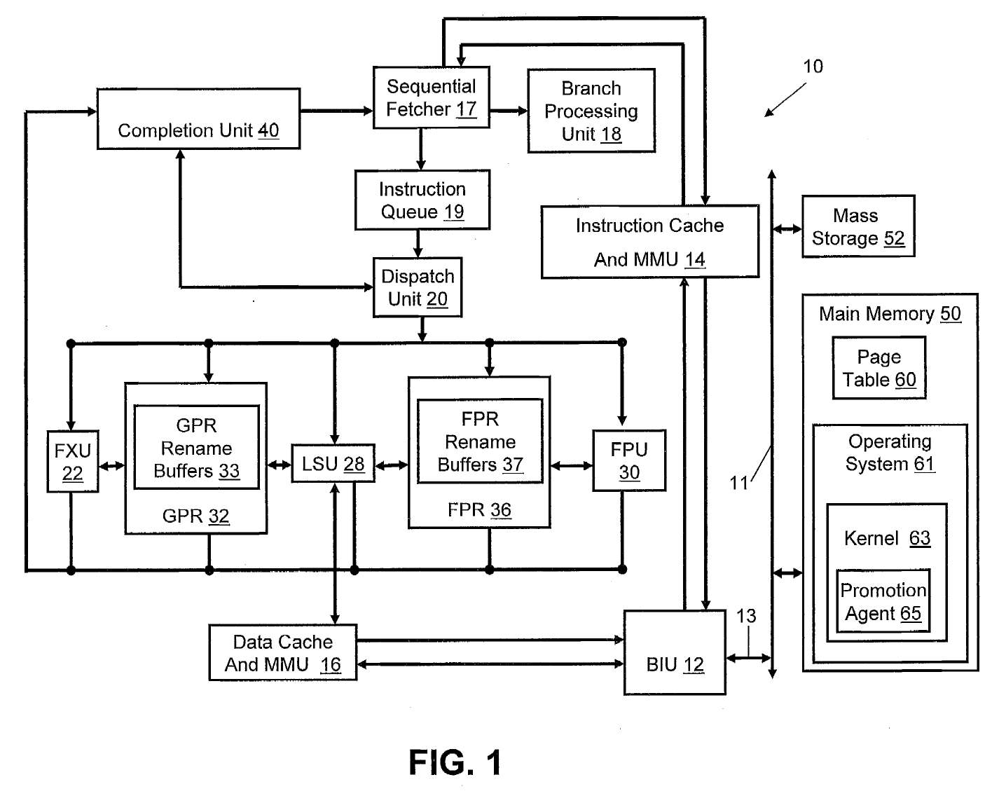

With reference now to the figures and in particular with reference to FIG. 1, there is depicted a block diagram of an illustrative embodiment of a data processing system for processing information in accordance with the invention recited within the appended claims. In the depicted illustrative embodiment, processor 10 comprises a single integrated circuit superscalar microprocessor. Accordingly, as discussed farther below, processor 10 includes various execution units, registers, buffers, memories, and other functional units, which are all formed by integrated circuitry. Processor 10 preferably comprises one of the POWER™ line of microprocessors available from IBM Corporation, which operates according to reduced instruction set computing (RISC) techniques; however, those skilled in the art will appreciate from the following description that other suitable processors can be utilized.

As illustrated in FIG. 1, processor 10 is coupled via bus interface unit (BIU) 12 to system bus 11, which includes address, data, and control buses. BIU 12 controls the transfer of information between processor 10 and other devices coupled to system bus 11, such as main memory 50 and nonvolatile mass storage 52. The data processing system illustrated in FIG. 1 preferably includes other unillustrated devices coupled to system bus 11, which are not necessary for an understanding of the following description and are accordingly omitted for the sake of simplicity.

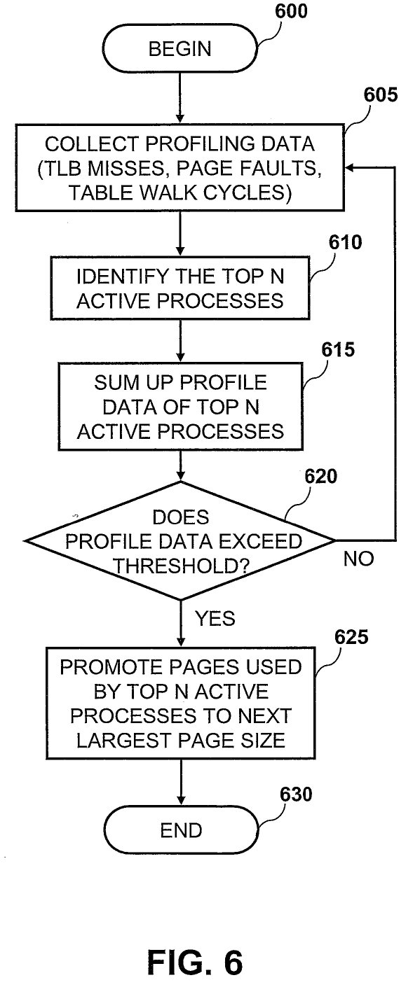

Code that populates main memory 50 includes an operating system (OS) 61. OS 61 includes kernel 63, which provides lower levels of functionality for OS 61 and essential services required by other parts of OS 61. The services provided by kernel 63 include memory management, process and task management, disk management, and input/output (I/O) management. According to the illustrative embodiment, kernel 63 includes a kernel-space promotion agent 65 (e.g., a kernel daemon) that provides the functionality shown in FIG. 6, which is discussed below. In an alternate embodiment, promotion agent 65 may instead be a user-space process, optionally forming a part of an application or middleware program. In such embodiments, some of the steps depicted in FIG. 6 may be performed by accessing facilities of operating system 61.

BIU 12 is connected to instruction cache and MMU (Memory Management Unit) 14 and data cache and MMU 16 within processor 10. High-speed caches, such as those within instruction cache and MMU 14 and data cache and MMU 16, enable processor 10 to achieve relatively fast access times to a subset of data or instructions previously transferred from main memory 50 to the caches, thus improving the speed of operation of the data processing system. Data and instructions stored within the data cache and instruction cache, respectively, are identified and accessed by address tags, which each comprise a selected number of high-order bits of the physical address of the data or instructions in main memory 50. Instruction cache and MMU 14 is further coupled to sequential fetcher 17, which fetches instructions for execution from instruction cache and MMU 14 during each cycle. Sequential fetcher 17 transmits branch instructions fetched from instruction cache and MMU 14 to branch processing unit (BPU) 18 for execution, but temporarily stores sequential instructions within instruction queue 19 for execution by other execution circuitry within processor 10.

In the depicted illustrative embodiment, in addition to BPU 18, the execution circuitry of processor 10 comprises multiple execution units for executing sequential instructions, including fixed-point unit (FXU) 22, load-store unit (LSU) 28, and floating-point unit (FPU) 30. Each of execution units 22, 28, and 30 typically executes one or more instructions of a particular type of sequential instructions during each processor cycle. For example, FXU 22 performs fixed-point mathematical and logical operations such as addition, subtraction, ANDing, ORing, and XORing, utilizing source operands received from specified general purpose registers (GPRs) 32 or GPR rename buffers 33. Following the execution of a fixed-point instruction, FXU 22 outputs the data results of the instruction to GPR rename buffers 33, which provide temporary storage for the result data until the instruction is completed by transferring the result data from GPR rename buffers 33 to one or more of GPRs 32. Conversely, FPU 30 typically performs single and double-precision floating-point arithmetic and logical operations, such as floating-point multiplication and division, on source operands received from floating-point registers (FPRs) 36 or FPR rename buffers 37. FPU 30 outputs data resulting from the execution of floating-point instructions to selected FPR rename buffers 37, which temporarily store the result data until the instructions are completed by transferring the result data from FPR rename buffers 37 to selected FPRs 36. As its name implies, LSU 28 typically executes floating-point and fixed-point instructions which either load data from memory (i.e., either the data cache within data cache and MMU 16 or main memory 50) into selected GPRs 32 or FPRs 36 or which store data from a selected one of GPRs 32, GPR rename buffers 33, FPRs 36, or FPR rename buffers 37 to memory.

Processor 10 employs both pipelining and out-of-order execution of instructions to further improve the performance of its superscalar architecture. Accordingly, instructions can be executed by FXU 22, LSU 28, and FPU 30 in any order as long as data dependencies are observed. In addition, instructions are processed by each of FXU 22, LSU 28, and FPU 30 at a sequence of pipeline stages. As is typical of high-performance processors, each sequential instruction is processed at five distinct pipeline stages, namely, fetch, decode/dispatch, execute, finish, and completion.

During the fetch stage, sequential fetcher 17 retrieves one or more instructions associated with one or more memory addresses from instruction cache and MMU 14. Sequential instructions fetched from instruction cache and MMU 14 are stored by sequential fetcher 17 within instruction queue 19. In contrast, sequential fetcher 17 removes (folds out) branch instructions from the instruction stream and forwards them to BPU 18 for execution. BPU 18 includes a branch prediction mechanism, which in one embodiment comprises a dynamic prediction mechanism, such as a branch history table, that enables BPU 18 to speculatively execute unresolved conditional branch instructions by predicting whether or not the branch will be taken.

During the decode/dispatch stage, dispatch unit 20 decodes and dispatches one or more instructions from instruction queue 19 to execution units 22, 28, and 30, typically in program order. In addition, dispatch unit 20 allocates a rename buffer within GPR rename buffers 33 or FPR rename buffers 37 for each dispatched instruction's result data. Upon dispatch, instructions are also stored within the multiple-slot completion buffer of completion unit 40 to await completion. According to the depicted illustrative embodiment, processor 10 tracks the program order of the dispatched instructions during out-of-order execution utilizing unique instruction identifiers.

During the execute stage, execution units 22, 28, and 30 execute instructions received from dispatch unit 20 opportunistically as operands and execution resources for the indicated operations become available. Each of execution units 22, 28, and 30 are preferably equipped with a reservation station that stores instructions dispatched to that execution unit until operands or execution resources become available. After execution of an instruction has terminated, execution units 22, 28, and 30 store data results, if any, within either GPR rename buffers 33 or FPR rename buffers 37, depending upon the instruction type. Then, execution units 22, 28, and 30 notify completion unit 40 which instructions have finished execution. Finally, instructions are completed in program order out of the completion buffer of completion unit 40. Instructions executed by FXU 22 and FPU 30 are completed by transferring data results of the instructions from GPR rename buffers 33 and FPR rename buffers 37 to GPRs 32 and FPRs 36, respectively. Load and store instructions executed by LSU 28 are completed by transferring the finished instructions to a completed store queue or a completed load queue from which the load and store operations indicated by the instructions will be performed.

The performance of processor 10 may be monitored in hardware through performance monitor counters (PMCs) 40 within processor 10. Additional performance information can be collected by software, such as operating system 61.

In an exemplary embodiment, processor 10 utilizes a 32-bit address bus and therefore has a 4 Gbyte virtual address space. (Of course, in other embodiments 64-bit or other address widths can be utilized.) The 4 Gbyte virtual address space is partitioned into a number of memory pages, each of which has a respective Page Table Entry (PTE) address descriptor that associates the virtual address of the memory page with the corresponding physical address of the memory page in main memory 50. The memory pages are preferably of multiple different sizes, for example, 4 KB, 16 KB, 64 KB, 256 KB, 1 MB, 4 MB and 16 MB. (Of course, any other size of memory pages may alternatively or additionally be employed.) As illustrated in FIG. 1, the PTEs describing the memory pages resident within main memory 50 together comprise page table 60, which is created by the operating system of the data processing system utilizing one of two hashing functions that are described in greater detail below.

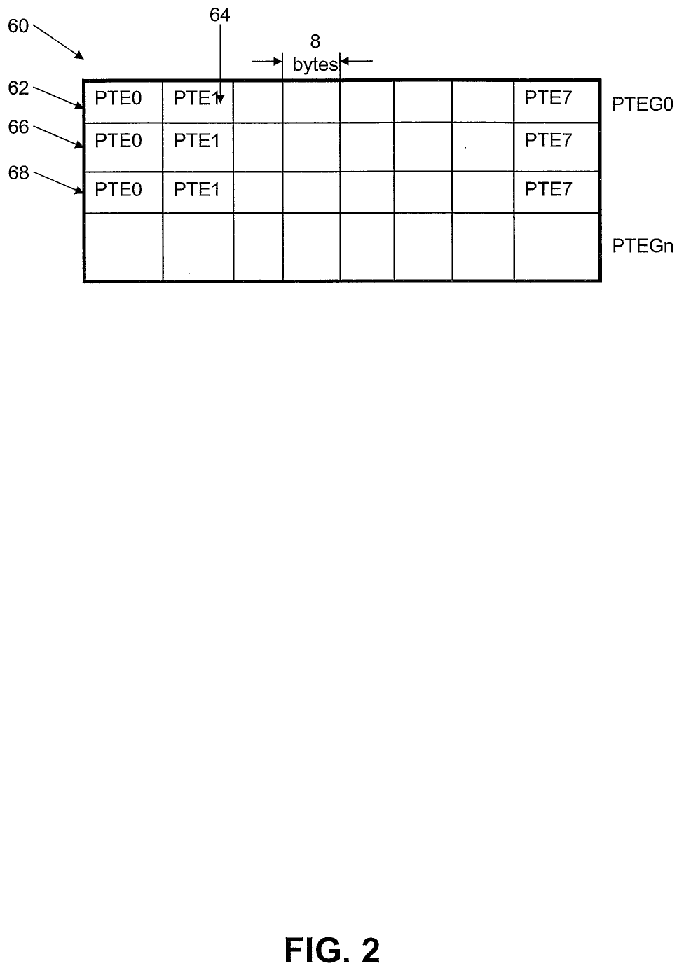

Referring now to FIG. 2, there is depicted a more detailed block diagram representation of page table 60 in main memory 50. Page table 60 is a variable-sized data structure comprised of a number of Page Table Entry Groups (PTEGs) 62, which can each contain up to 8 PTEs 64. As illustrated, each PTE 64 is eight bytes in length; therefore, each PTEG 62 is 64 bytes long. Each PTE 64 can be assigned to any location in either of a primary PTEG 66 or a secondary PTEG 68 in page table 60 depending upon whether a primary hashing function or a secondary hashing function is utilized by the operating system to set up the associated memory page in memory. The addresses of primary PTEG 66 and secondary PTEG 68 serve as entry points for page table search operations.

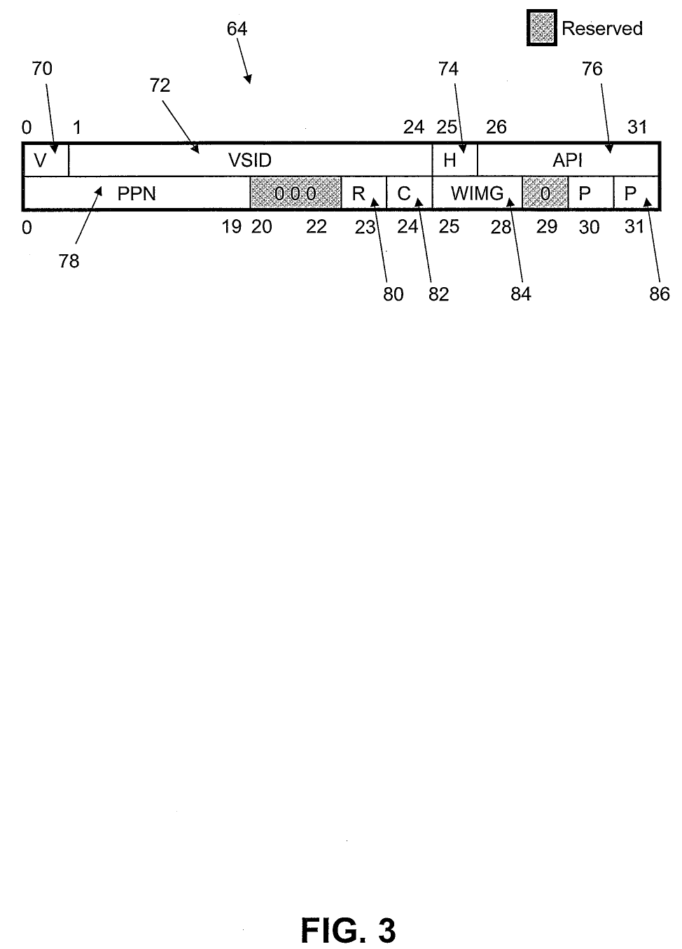

With reference now to FIG. 3, there is illustrated a pictorial representation of the structure of each PTE 64 within page table 60. As illustrated, the first four bytes of each 8-byte PTE 64 include a valid bit 70 for indicating whether PTE entry 64 is valid, a Virtual Segment ID (VSID) 72 for specifying the high-order bits of a virtual page number, a hash function identifier (H) 74 for indicating which of the primary and secondary hash functions was utilized to create PTE 64, and an Abbreviated Page Index (API) 76 for specifying the low order bits of the virtual page number. Hash function identifier 74 and the virtual page number specified by VSID 72 and API 76 are used to locate a particular PTE 64 during a search of page table 60 or the Translation Lookaside Buffers (TLBs) maintained by instruction cache and MMU 14 and data cache and MMU 16, which are described below. Still referring to FIG. 3, the second four bytes of each PTE 64 include a Physical Page Number (PPN) 78 identifying the corresponding physical memory page, a page size field 79 for indicating in encoded format the size of the page, a referenced (R) bit 80 and changed (C) bit 82 for keeping history information about the memory page, memory access attribute bits 84 for specifying memory update modes for the memory page, and page protection (PP) bits 86 for defining access protection constraints for the memory page.

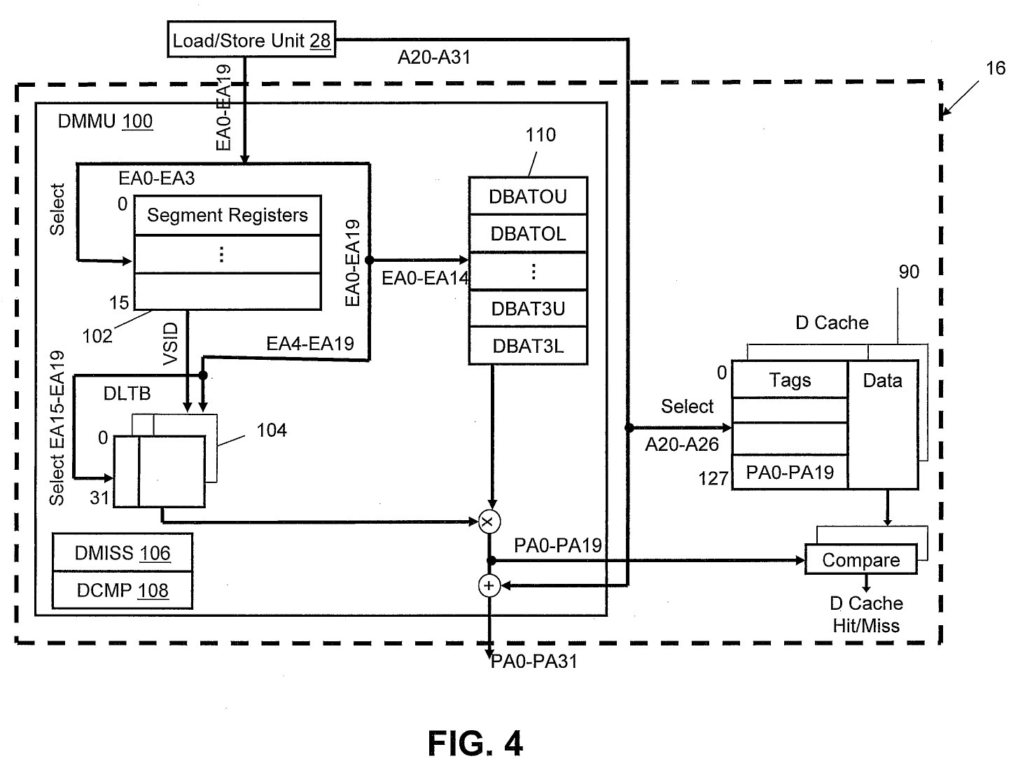

Referring now to FIG. 4, there is depicted a more detailed block diagram representation of data cache and MMU 16 of processor 10. In particular, FIG. 4 illustrates the address translation mechanism utilized by data cache and MMU 16 to translate effective addresses (EAs) specified within data access requests received from LSU 28 into physical addresses assigned to locations within main memory 50 or to devices within the data processing system that support memory-mapped I/O. In order to permit simultaneous address translation of data and instruction addresses and therefore enhance processor performance, instruction cache and MMU 14 contains a corresponding address translation mechanism for translating EAs contained within instruction requests received from sequential fetcher 17 into physical addresses within main memory 50.

As depicted in FIG. 4, data cache and MMU 16 includes a data cache 90 and a data MMU (DMMU) 100. In the depicted illustrative embodiment, data cache 90 comprises a two-way set associative cache including 128 cache lines having 32 bytes in each way of each cache line. Thus, only 4 PTEs within a 64-byte PTEG 62 can be accommodated within a particular cache line of data cache 90. Each of the 128 cache lines corresponds to a congruence class selected utilizing address bits 20-26, which are identical for both effective and physical addresses. Data mapped into a particular cache line of data cache 90 is identified by an address tag comprising bits 0-19 of the physical address of the data within main memory 50.

As illustrated, DMMU 100 contains segment registers 102, which are utilized to store the Virtual Segment Identifiers (VSIDs) of each of the sixteen 256-Mbyte regions into which the 4 Gbyte virtual address space of processor 10 is subdivided. A VSID stored within a particular segment register is selected by the 4 highest-order bits (bits 0-3) of an EA received by DMMU 100. DMMU 100 also includes Data Translation Lookaside Buffer (DTLB) 104, which in the depicted embodiment is a two-way set associate cache for storing copies of recently-accessed PTEs. DTLB 104 comprises 32 lines, which are indexed by bits 15-19 of the EA. Multiple PTEs mapped to a particular line within DTLB 104 by bits 15-19 of the EA are differentiated by an address tag comprising bits 10-14 of the EA. In the event that the PTE required to translate a virtual address is not stored within DTLB 104, DMMU 100 stores that 32-bit EA of the data access that caused the DTLB miss within DMISS register 106. In addition, DMMU 100 stores the VSID, H bit, and API corresponding to the EA within DCMP register 108 for comparison with the first 4 bytes of PTEs during a table search operation. DMMU 100 further includes Data Block Address Table (DBAT) array 110, which is utilized by DMMU 100 to translate the addresses of data blocks (i.e., variably-sized regions of virtual memory) and is accordingly not discussed further herein.

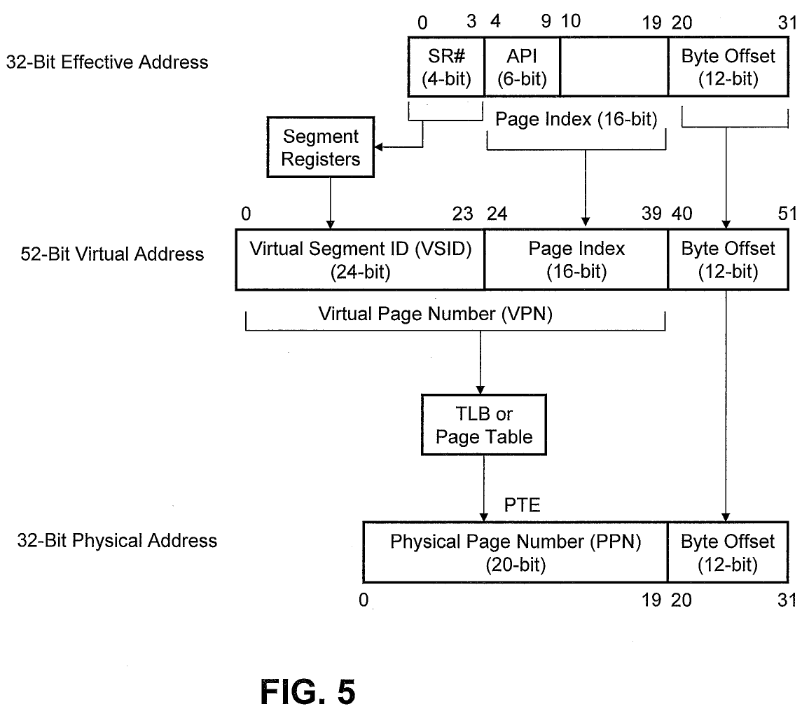

With reference now to FIG. 5, there is illustrated a high-level flow diagram of the address translation process utilized by processor 10 to translate EAs into physical addresses. As depicted in FIGS. 4 and 5, LSU 28 transmits the 32-bit EA of each data access request to data cache and MMU 16. Bits 0-3 of the 32-bit EA are utilized to select one of the 16 segment registers 102 in DMMU 100. The 24-bit VSID stored in the selected one of segment registers 102, which together with the 16-bit page index and 12-bit byte offset of the EA form a 52-bit virtual address, is passed to DTLB 104. Bits 15-19 of the EA then select two PTEs stored within a particular line of DTLB 104. Bits 10-14 of the EA are compared to the address tags associated with each of the selected PTEs and the VSID field and API field (bits 4-9 of the EA) are compared with corresponding fields in the PTEs. In addition, the valid (V) bit of each PTE is checked. If the comparisons indicate that a match is found, the PP bits of the matching PTE are checked for an exception, and if these bits do not cause an exception, the 20-bit PPN (Physical Page Number) contained in the matching PTE is passed to data cache 90 to determine if the requested data results in a cache hit. As shown in FIG. 5, concatenating the 20-bit PPN with the 12-bit byte offset specified by the EA produces a 32-bit physical address of the requested data in main memory 50.

Although 52-bit virtual addresses are usually translated into physical addresses by reference to DTLB 104, if a DTLB miss occurs, that is, if the PTE required to translate the virtual address of a particular memory page into a physical address is not resident within DTLB 104, DMMU 100 searches page table 60 in main memory 50 in order to reload the required PTE into DTLB 104 and translate the virtual address of the memory page. The table search operation performed by DMMU 100 checks the PTEs within the primary and secondary PTEGs in a selectively non-sequential order such that processor performance is enhanced.

Turning now to FIG. 6, there is illustrated a high level logical flowchart of an exemplary method of adjusting the sizes of memory pages in accordance with the present invention. The process begins at block 600 in response to invocation of page promotion agent 65, which preferably performs the remainder of the illustrated steps in an automated manner. When page promotion agent 65 first runs, the sizes of all of the memory pages allocated by operating system 61 to the active processes in data processing system 10 may be, but are not required to be, of uniform size.

As depicted at block 603, page promotion agent 65 resets a timer (e.g., one of PMCs 40) utilized to specify the interval (as measured in CPU cycles or time) over which profiling data is to be collected. In addition, page promotion agent 65 clears the contents of performance monitoring data storage (e.g., a performance monitoring buffer in main memory 50 and/or other PMCs 40). Next, at block 605, page promotion agent 65 (or other portion of kernel 63) and/or performance monitoring hardware with processor 10 collect profiling data corresponding to the active processes within processor 10 over the timer-specified interval (e.g., 5 seconds) and store the profiling data within performance monitoring data storage, such as the performance monitor buffer in main memory 50 and/or PMCs 40 within processor 10. In one embodiment, the profiling data includes, but is not limited to, the CPU cycles consumed by each active process, the number of TLB misses, the number of page faults, and the time spent by performing page table walks during table search operations.

As shown in block 610, at the end of the specified interval, page promotion agent 65 identifies the top N active processes within processor 10 by reference to the profiling data, where N is an integer that may be defined, for example, by default or by a user of the data processing system through an interface presented by operating system 61. Page promotion agent 65 combines the profile data for each metric (e.g., total TLB misses, total page faults, and total time spend performing page table walks) of the top N active processes, as depicted in block 615. As shown in block 620, promotion agent 65 then determines whether the aggregate value of the profile data for a specified number (e.g., one) of the metrics has reached a threshold value, which may defined by the user or by default. If none of the aggregate values of the profile data for the top N active processes has reached the corresponding threshold values, the process returns to block 603 and page promotion agent 65 continues to collect profile data during a subsequent time interval.

If, however, page promotion agent 65 determines at block 620 that the aggregate value(s) of a specified number (e.g., one) of the profile data corresponding to the top N active processes has reached the associated threshold value(s), page promotion agent 65 promotes the memory pages of the top N active processes to the next-largest page size (e.g., from 16 KB pages to 64 KB pages) and modifies the PTEs of the top N active processes accordingly, as shown in block 625. Swapped out pages corresponding to the top N active processes are thus swapped back in to larger pages.

Following block 625, the process passes to block 627, which illustrates a determination of whether or not page promotion agent 65 has been terminated, for example, through a shutdown of operating system 61 or through a system administrator individually terminating page promotion agent 65. If so, page promotion agent 65 then terminates the process shown in FIG. 6, as depicted in block 630. If not, the process depicted in FIG. 6 returns to block 603, which has been described. The present invention thus reduces the number of TLB misses and reduces the cost of page fault handling, thereby improving system performance.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. A method of data processing in a data processing system having system memory, said method comprising:
allocating to each of a plurality of active processes a respective collection of virtual memory pages, wherein each page of virtual memory has a respective page size and a respective virtual memory address mapped to a respective physical address in system memory;
recording mappings between virtual memory addresses of allocated virtual memory pages and physical addresses in page table entries of a page table in said system memory;
dynamically collecting profile data for the plurality of active processes during processing by the plurality of active processes;
evaluating the profile data of one or more most active processes among the plurality of processes with reference to at least one threshold; and
in response to a determination that said at least one threshold has been reached, promoting the virtual memory pages allocated to said one or more most active processes to a larger page size and updating the page table entries for the virtual memory pages accordingly.

2. The method of claim 1, wherein said step of collecting profile data includes collecting at least one of a set including a number of Translation Lookaside Buffer (TLB) misses, a number of page faults, and a metric indicative of processing time expended searching the page table for page table entries.

3. The method of claim 1, and further comprising permitting a user to specify a number of said one or more most active processes.

4. The method of claim 1, wherein:
said data processing system supports at least three different page sizes; and
said promoting step comprises promoting the virtual memory pages allocated to said one or more most active processes to a next largest size.

5. The method of claim 1, and further comprising identifying the one or more most active processes by reference to the profiling data.

6. The method of claim 1, wherein said evaluating and promoting steps are performed by a kernel process of an operating system of the data processing system.

7. A program product, comprising:
a data storage medium; and
program code within the data storage medium, wherein said program code performs a method of data processing in a data processing system having system memory and a plurality of active processes, wherein each of a plurality of active processes has a respective collection of virtual memory pages, each page of virtual memory having a respective page size and a respective virtual memory address mapped to a respective physical address in system memory, and wherein mappings between virtual memory addresses of allocated virtual memory pages and physical addresses are recorded in page table entries of a page table in said system memory, said method comprising:
dynamically collecting profile data for the plurality of active processes during processing by the plurality of active processes;
evaluating the profile data of one or more most active processes among the plurality of processes with reference to at least one threshold; and
in response to a determination that said at least one threshold has been reached, promoting the virtual memory pages allocated to said one or more most active processes to a larger page size and updating the page table entries for the virtual memory pages accordingly.

8. The program product of claim 7, wherein said step of collecting profile data includes collecting at least one of a set including a number of Translation Lookaside Buffer (TLB) misses, a number of page faults, and a metric indicative of processing time expended searching the page table for page table entries.

9. The program product of claim 7, wherein said method further comprises permitting a user to specify a number of said one or more most active processes.

10. The program product of claim 7, wherein:
said data processing system supports at least three different page sizes; and
said promoting comprises promoting the virtual memory pages allocated to said one or more most active processes to a next largest size.

11. The program product of claim 7, wherein said method further comprises identifying the one or more most active processes by reference to the profiling data.

12. The program product of claim 7, wherein said program code includes a kernel process of an operating system of the data processing system.

13. A data processing system, comprising:
a processor;
data storage coupled to the processor, said data storage including a system memory having a page table containing page table entries recording mappings between virtual memory addresses of allocated virtual memory pages and physical addresses in said system memory, said data storage further including program code that performs a method including steps of:
allocating to each of a plurality of active processes a respective collection of virtual memory pages, wherein each page of virtual memory has a respective page size and a respective virtual memory address mapped to a respective physical address in system memory;
dynamically collecting profile data for the plurality of active processes during processing by the plurality of active processes;
evaluating the profile data of one or more most active processes among the plurality of processes with reference to at least one threshold; and
in response to a determination that said at least one threshold has been reached, promoting the virtual memory pages allocated to said one or more most active processes to a larger page size and updating the page table entries for the virtual memory pages accordingly.

14. The data processing system of claim 13, wherein said step of collecting profile data includes collecting at least one of a set including a number of Translation Lookaside Buffer (TLB) misses, a number of page faults, and a metric indicative of processing time expended searching the page table for page table entries.

15. The data processing system of claim 13, wherein said method further comprises permitting a user to specify a number of said one or more most active processes.

16. The data processing system of claim 13, wherein:
said data processing system supports at least three different page sizes; and
said promoting step comprises promoting the virtual memory pages allocated to said one or more most active processes to a next largest size.

17. The data processing system of claim 13, wherein said method further comprises identifying the one or more most active processes by reference to the profiling data.

18. The data processing system of claim 13, wherein said program code includes a kernel process of an operating system of the data processing system.
